(19) United States
(12) Patent Application Publication
(10) Pub. No.: US 2016/0134675 A1
(43) Pub. Date: May 12, 2016

(54) METHODS, DEVICES, AND MEDIA FOR SECURELY UTILIZING A NON-SECURED, DISTRIBUTED, VIRTUALIZED NETWORK RESOURCE WITH APPLICATIONS TO CLOUD-COMPUTING SECURITY AND MANAGEMENT

(71) Applicant: Porticor Ltd., Hod Hasharon (IL)

(72) Inventor: Gilad Parann-Nissany, Ramat Hasharon (IL)

(21) Appl. No.: 14/980,324

(22) Filed: Dec. 28, 2015

Related U.S. Application Data
(62) Division of application No. 12/887,547, filed on Sep. 22, 2010.
(60) Provisional application No. 61/244,980, filed on Sep. 23, 2009.

(51) Int. Cl. H04L 29/06

(52) U.S. Cl. CPC H04L 65/605; H04L 63/10

(57) ABSTRACT

The present invention discloses methods for securing information by transforming the information into individually-unintelligible parts, methods include: dividing an original data stream into a set of split data streams; applying a first invertible transformation function to the split data streams, the step of applying producing an intermediate set of data streams; and extracting a final set of data streams from the intermediate set by applying a selection rule which produces the final set, thereby transforming the original data stream into individually-unintelligible parts in the final set. Preferably, the method further includes: applying a second invertible transformation function to the final set to produce the intermediate set, wherein the second invertible transformation is an inverse function of the first invertible transformation; extracting the split streams from the intermediate set by applying a selection rule which produces the split data streams; and reconstructing the original data stream from the split data streams.

### CROSS REFERENCE TO RELATED APPLICATIONS

This patent application is a divisional application of, and claims priority to, U.S. patent application Ser. No. 12/887,547, filed on Sep. 22, 2010, and claims priority under 35 U.S.C. §119(e) to U.S. Provisional Application No. 61/244,980 filed Sep. 23, 2009, which are hereby incorporated by reference in their entirety.

### FIELD AND BACKGROUND OF THE INVENTION

The present invention relates to methods, devices, and media for securely utilizing a non-secured, distributed, virtualized network resource with applications to cloud-computing security and management.

A trend in modern computer networking, web-, and cloud-computing, is to rely on public, group, or virtualized resources. The IT marketplace offers public, private, and hybrid solutions for “virtualization” and “cloud computing.” This growing trend is occurring at many levels: infrastructure, platform, and software.

A recurring problem hampering such solutions is the fact that “virtualized” and/or “cloud” solutions are by their very nature non-secured and distributed. The resources may be physically owned by different entities other than the users, or may be shared among multiple users (having existing security, privacy, and trust concerns). This may occur within one legal entity or among different entities.

For example, a file may be saved in a network “storage cloud.” Since the storage cloud is a shared resource, a user is entrusting his/her data to a resource that is routinely accessed by many other users, over which the user has no control at all.

Vendors of cloud and virtualization solutions provide various mechanisms (e.g. authentication, authorization, and virtual private clouds) to ameliorate this state of affairs. Such approaches are significant but incomplete. Such mechanisms do not solve various important problems (e.g. encryption at rest, single point for security handling, and requiring the user to trust the provider, the provider's implementation, or the provider's staff).

Of course, one solution for the security-conscious consumer is to avoid shared resources altogether. However, such an option is an unpleasant choice for the user, since modern shared resources provide many economic, operational, and technical benefits.

It would be desirable to have methods, devices, and media for securely utilizing a non-secured, distributed, virtualized network resource with applications to cloud-computing security and management. Such methods, devices, and media would, inter alia, overcome the limitations mentioned above.

### SUMMARY OF THE INVENTION

It is the purpose of the present invention to provide methods, devices, and media for securely utilizing a non-secured, distributed, virtualized network resource with applications to cloud-computing security and management.

In the interest of clarity, several terms which follow are specifically defined for use herein. The term “virtualization” is used herein to refer to any means of executing software in an environment separated from the underlying hardware resources, including, but not limited to: hardware virtualization, software virtualization, memory virtualization, database virtualization, data virtualization, storage virtualization, application virtualization, desktop virtualization, and network virtualization.

The term “resource” is used herein to refer to any computing service which provides data-storage, computing, and/or networking capacity using hardware provide by the service provider.

Virtualized (or cloud) resources often utilize an API (application programming interface). Examples of such APIs are the Amazon® API for their S3 and EC2 resources; Microsoft® Azure APIs for their Azure Storage, Azure Compute, or Azure Fabric resources; and Google® AppEngine APIs for their BigTable resource. Similarly, private and hybrid providers (e.g. Eucalyptus Systems) also often provide APIs.

The term “resource interface” is used herein to refer to the more general category of interfaces which provide a capability to use a distributed resource. APIs, such as those mentioned above, are examples of resource interfaces. Using a resource interface entails security concerns as mentioned above. Preferred embodiments of the present invention enable a user to use such APIs (without replacing the interfaces) while providing enhanced security.

Preferred embodiments of the present invention enable a security-conscious consumer to use available public and shared resources from providers or vendors, while enjoying full security and control. Preferred embodiments of the present invention provide the ability to secure resources that are non-secured, without impairing the functionality of the resources. Preferred embodiments of the present invention enable non-secured resources to be secured and controlled more completely, while maintaining the benefits of the emerging shared-resource model.

Preferred embodiments of the present invention secure the non-secured resources without replacing the resources, but rather make the resources more secure while in use. Such embodiments can employ existing mechanisms (e.g. authentication, authorization, and encryption) in conjunction with additional mechanisms in stand-alone implementations or enhancement implementations to existing mechanisms.

Preferred embodiments of the present invention enable the establishment of trust in an “imperfectly-trusted” environment, allowing a user to have confidence in the security of shared or public resources, even if the user does not have perfect trust in the provider of the resource, the provider's implementation, or the provider's staff.

Preferred embodiments of the present invention enable the enhancement of security and trust beyond what is achievable in private or unshared solutions. Preferred embodiments of the present invention are applicable in public, private, and hybrid scenarios.

Preferred embodiments of the present invention enable a user to use resource interfaces (without replacing the interfaces) while providing enhanced security by placing a networking proxy (also known as a gateway) between a user and a networking resource, so the user does not access the networking resource directly. Rather, the user accesses the networking resource through the proxy. Such embodiments utilize a “resource interface proxy.”

The resource interface proxy is placed between a user and a distributed, network resource. The resource interface proxy can include several aspects that allow the proxy to secure the resource (not all aspects are necessary for the proxy to provide enhanced security). The resource interface proxy can be configured to:
(1) Act at the resource interface: all access to and from the resource via its (native) interface is routed through the resource interface proxy; the resource interface proxy is therefore able to introduce security measures without interfering with the internal implementation of the resource;
(2) Be aware of the distributed resource interface that the proxy is securing: the resource interface proxy knows enough about the specific resource API in order to identify the correct place to introduce security measures and security algorithms (such places are often different for different resources and different APIs, so this awareness assists the resource interface proxy in its duties to secure and control a variety of resources);
(3) Apply rich security measures: the resource interface proxy is capable of applying multiple security measures (e.g. validating parameters, sanitizing parameters, encrypting data, decrypting data, logging security-related events, and algorithms that exploit the distributed nature of resources to enhance security or safety) to the information going to and coming from the resource;
(4) Act as a single point for applying security and control: all information passed to and from the resource interface may be passed through the resource interface proxy as far as desired;
(5) Transparently pass through the resource API as far as desired: while the resource interface proxy applies security measures to the resource interface, the resource interface proxy also does not markedly change the resource's API; as a consequence, anyone wishing to use the secured resource still has an API that is recognizable and usable by well-established techniques. (adaptations to well-established techniques are necessary only insofar as the applied security measures require the adaptations); and
(6) Be configured through rules and/or algorithms: the resource interface proxy may be configured both by rules and (in more complex cases) by algorithms that apply the rich security measures.

All of the above aspects available to the resource interface proxy are applied correctly to the resource since the resource interface proxy is “aware” of the resource, as noted above.

Other preferred embodiments of the present invention provide algorithmic methods for advanced security applications.

Therefore, according to the present invention, there is provided for the first time a method for securing information by transforming the information into individually-unintelligible parts, the method including the steps of: (a) dividing an original data stream into a set of split data streams; (b) applying a first invertible transformation function to the split data streams, the step of applying producing an intermediate set of data streams; and (c) extracting a final set of data streams from the intermediate set by applying a selection rule which produces the final set, thereby transforming the original data stream into individually-unintelligible parts in the final set.

Preferably, the first invertible transformation function requires all elements of the final set to be available in order to reconstruct the original data stream.

Preferably, the method further includes the steps of: (d) applying a second invertible transformation function to the final set to produce the intermediate set, wherein the second invertible transformation is an inverse function of the first invertible transformation; (e) extracting the split streams from the intermediate set by applying a selection rule which produces the split data streams; and (f) reconstructing the original data stream from the split data streams.

Preferably, the method further includes the steps of: (d) associating a key set with the final set such that every element of the final set has an associated key; (e) storing the final set on a computing-service resource, wherein the key set specifies locations of the elements in the computing-service resource; and (f) ensuring that no intelligible reference regarding a key relationship between the key set and the final set is present on the computing-service resource, thereby preventing detection of the elements by masking an element relationship among the elements.

According to the present invention, there is provided for the first time a non-transitory computer-readable storage medium having computer-readable code embodied on the non-transitory computer-readable storage medium, the computer-readable code including: (a) program code for dividing an original data stream into a set of split data streams; (b) program code for applying a first invertible transformation function to the split data streams, the applying producing an intermediate set of data streams; and (c) program code for extracting a final set of data streams from the intermediate set by applying a selection rule which produces the final set, thereby transforming the original data stream into individually-unintelligible parts in the final set.

Preferably, the first invertible transformation function requires all elements of the final set to be available in order to reconstruct the original data stream.

Preferably, the computer-readable code further includes: (d) program code for applying a second invertible transformation function to the final set to produce the intermediate set, wherein the second invertible transformation is an inverse function of the first invertible transformation; (e) program code for extracting the split streams from the intermediate set by applying a selection rule which produces the split data streams; and (f) program code for reconstructing the original data stream from the split data streams.

Preferably, the computer-readable code further includes: (d) program code for associating a key set with the final set such that every element of the final set has an associated key; (e) program code for storing the final set on a computing-service resource, wherein the key set specifies locations of the elements in the computing-service resource; and (f) program code for ensuring that no intelligible reference regarding a key relationship between the key set and the final set is present on the computing-service resource, thereby preventing detection of the elements by masking an element relationship among the elements.

According to the present invention, there is provided for the first time a device for securing information by transforming the information into individually-unintelligible parts, the device including: (a) a data-processing unit including: (i) a CPU for performing computational operations; and (ii) a memory module for storing data; and (b) a deployed security mechanism, residing on the data-processing unit, configured for: (i) dividing an original data stream into a set of split data streams; (ii) applying a first invertible transformation function to the split data streams, the step of applying producing an intermediate set of data streams; and (iii) extracting a final set of data streams from the intermediate set by applying a selection rule which produces the final set, thereby transforming the original data stream into individually-unintelligible parts in the final set.

Preferably, the first invertible transformation function requires all elements of the final set to be available in order to reconstruct the original data stream.

Preferably, the deployed security mechanism is further configured for: (iv) applying a second invertible transformation function to the final set to produce the intermediate set, wherein the second invertible transformation is an inverse function of the first invertible transformation; (v) extracting the split streams from the intermediate set by applying a selection rule which produces the split data streams; and (vi) reconstructing the original data stream from the split data streams.

Preferably, the deployed security mechanism is further configured for: (iv) associating a key set with the final set such that every element of the final set has an associated key; (v) storing the final set on a computing-service resource, wherein the key set specifies locations of the elements in the computing-service resource; and (vi) ensuring that no intelligible reference regarding a key relationship between the key set and the final set is present on the computing-service resource, thereby preventing detection of the elements by masking an element relationship among the elements.

These and further embodiments will be apparent from the detailed description and examples that follow.

### BRIEF DESCRIPTION OF THE DRAWINGS

The present invention is herein described, by way of example only, with reference to the accompanying drawing, wherein:

FIG. 1 is a simplified flowchart of the major operational steps in an exemplary implementation of a resource interface proxy, according to preferred embodiments of the present invention;

FIG. 2 is a simplified schematic block diagram of a virtual safety-deposit box implemented using a resource interface proxy, according to preferred embodiments of the present invention.

### DESCRIPTION OF THE PREFERRED EMBODIMENTS

The present invention relates to methods, devices, and media for securely utilizing a non-secured, distributed, virtualized network resource with applications to cloud-computing security and management. The principles and operation for such methods, devices, and media, according to the present invention, may be better understood with reference to the accompanying description and the drawing.

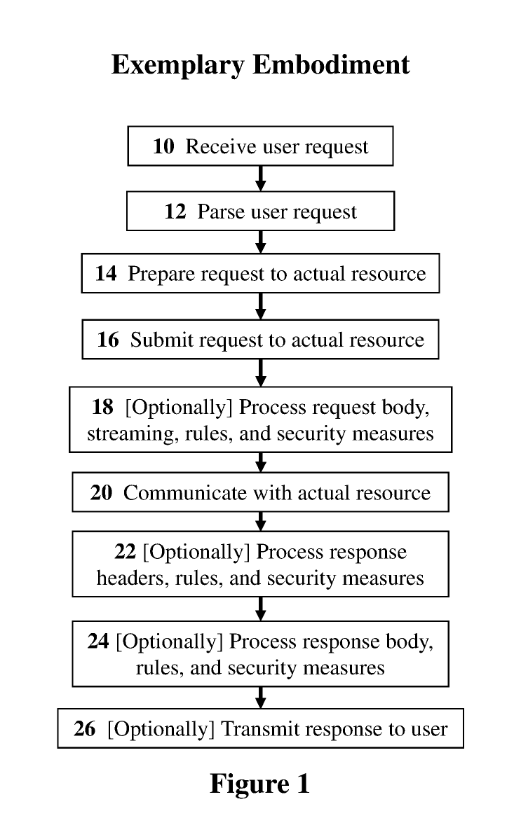

Referring now to the drawing, FIG. 1 is a simplified flowchart of the major operational steps in an exemplary implementation of a resource interface proxy, according to preferred embodiments of the present invention. In this embodiment, the resource interface proxy is securing a specific set of cloud-computing resources; therefore, we give this proxy the more specific name of a “cloud interface proxy.” The process starts when a user request is received by the cloud interface proxy (Step 10). From the user's perspective, the cloud interface proxy is transparent; the user communicates with the API exposed by the cloud interface proxy.

As noted above, this API appears similar to the API of the cloud resource (e.g. HTTP-based REST API), differing from the cloud-resource API only by the methods of signing and processing of URLs and addresses by the cloud interface proxy. The cloud-resource API is secured through secure communications (e.g. SSL/HTTPS). The user request can include, for example, a URL, headers, and a request body (referred to herein as “request elements”). Step 10 can optionally occur over an encrypted communication channel.

The cloud interface proxy then parses the user request (Step 12), allowing the cloud interface proxy in order to understand what needs to be done with the request, as well as taking certain security measures. During this step, headers, URLs, and all parameters are validated and sanitized, and appropriate rules are applied (depending on the configuration). Furthermore, descriptive metadata is stored in the user request for future reference.

The cloud interface proxy prepares the user request for transmitting to the cloud resource (Step 14). Such preparation includes:
(a) calculating a “signature” to comply with the authentication rules of the cloud resource (many cloud resources have rules that define the signature that the cloud resource expects to receive);
(b) modifying the request URL and headers to be in compliance with the cloud-resource expectations; and
(c) applying appropriate rules (depending on the configuration).

The cloud interface proxy then submits the actual request to the cloud resource (Step 16). The cloud interface proxy behaves appropriately for the types of requests that are possible for the given cloud-resource API. For example, for a REST API, the types of requests possible include GET, PUT, POST, DELETE, and HEAD. The body of the request is handled in an optional “body callback” (Step 18). Since the body of a user request may be large, the cloud interface proxy has the optional capability to “stream” the request body.

Streaming the request body means handling only part of the body at a time; therefore, it is not necessary to load the entire request body into memory. This option conserves memory, and also increases processing speed. The cloud interface proxy does not need to wait for the entire request body to be transmitted from the user, and can initiate communication with the cloud resource immediately. Furthermore, rules and security measures may be applied here. The rules may be configured as mentioned, while a security-algorithm “hook” allows for calls to desired security algorithms (such as those mentioned above).

The cloud interface proxy then communicates with the API exposed by the cloud resource (Step 20). As an example, the cloud interface proxy could be implemented in parts of Amazon® Web Services (AWS), such as parts of the Amazon® S3 (Simple Storage Service) resource interface and the Amazon® EC2 (Elastic Compute Cloud) resource interface. It is understood that a more general implementation could be enabled for many other distributed resource interfaces on the market, as well as alternate implementations for AWS. In the case of AWS, the API is an HTTP-based REST API. The API is secured through secure communications (e.g. SSL/HTTPS). The cloud resource then processes the user request and may return a result (e.g. success or failure codes, headers, and a result body).

In the event that there is a response, the cloud interface proxy processes the response of the cloud resource. The header and result codes (referred to herein as “response elements”) of the response are handled in a “header callback” (Step 22), and the body of the response are handled in a “body callback” (Step 24). Some headers may be simply transmitted back to the user, while some headers may be processed or added by the cloud interface proxy based on rules and algorithms (according to configuration and/or security hooks) before being transmitted to the user. The response body (also a response element) may be optionally streamed to conserve memory and improve performance. Furthermore, descriptive metadata is retrieved from the request response. Rules and security measures may be applied as well. The rules may be configured, while a security-algorithm hook allows for calls to desired security algorithms. The response is then transmitted to the user by the cloud interface proxy using secure communications methods (e.g. SSL/HTTPS) (Step 26). Step 26 can optionally occur over an encrypted communication channel.

In some embodiments of the present invention, implementations for various software utilities (e.g. encryption, decryption, authentication, authorization, logging, forensic support, and error handling) may be used in the steps of FIG. 1. Implementation of the process flow of FIG. 1 can be performed in various computing languages (e.g. PHP 5.2.10 or C++ running in the environment of an Apache 2.2.11 server on the Win32 (XP) operating system).

To highlight the aspects mentioned above in the context of FIG. 1, the cloud interface proxy is operationally positioned between the user and the interfaces of the cloud resource, ensuring all requests go through the proxy without interfering with the internal processes of the cloud resource (an example of aspect (1): Act at the resource interface). In the AWS example, the cloud interface proxy is aware of parts of two interfaces, EC2 and S3 (an example of aspect (2): Be aware of the distributed resource interface that the proxy is securing). The cloud interface proxy implements various software utilities mentioned above and algorithms described below (an example of aspect (3): Apply rich security measures).

Furthermore, the cloud interface proxy ensures that all information passed to and from the cloud-resource API goes through the proxy (an example of aspect (4): Act as a single point for applying security and control). The API that the user sees is substantially the same API exposed by the cloud resource; the cloud interface proxy modifies the API (in the implementation of FIG. 1) only in the details of signing requests (an example of aspect (5): Transparently pass through the resource API as far as desired). The cloud interface proxy is configurable both by rules and algorithms that apply the rich security measures (an example of aspect (6): Be configured through rules and/or algorithms).

Computer algorithms can be used to enhance security or safety by exploiting the distributed nature of resources. Distributed resources are typically shared. Such sharing of resources is usually perceived as a security liability. In some preferred embodiments of the present invention, information is secured by transforming the information into individually-unintelligible parts. Such embodiments enable a stream of data, S, to be transformed into several streams of data, {s₁, s₂, s₃, . . . sₖ}. The technique (as embodied in the present invention) for doing so ensures that each individual stream sⱼ is unintelligible, as well as each subset of the streams is unintelligible. Yet, if the full set {s₁, s₂, s₃, . . . sₖ} is available, the original stream S can be reconstructed.

As an example, consider a stream of data, S, wherein:

S=[b₁,b₂,b₃, . . . bₙ].

Each “bₓ” may be a byte or bit of data, for example. Such a stream may be the contents of a data file, a message, or any other stream of information.

Now consider splitting S into several different parts by the following method. First divide the original stream of bₓ into “k-tuples” (each of equal length k). Padding may be applied if n is not divisible by k. Let l be the number of tuples created. Such splitting can be performed in many ways. A simple example is by taking in order every k-appearances of bₓ in order to form the following tuple:

$$\begin{matrix}{t}_{1} = [ {b}_{1} , {b}_{2} , {b}_{3} , … {b}_{k} ] ; \\ {t}_{2} = [ {b}_{k + 1} , {b}_{k + 2} , {b}_{k + 3} , … {b}_{2 k} ] ; \\ … \\ {t}_{l} = [ {b}_{n - k + 1} , {b}_{n - k + 2} , {b}_{n - k + 3} , … {b}_{n} ] .\end{matrix}$$

A different notation for this last equation is to name each bₓ by the twin indices of its tuple and its place within the tuple as follows:

$${t}_{1} = [ {t}_{1 , 1} , {t}_{1 , 2} , {t}_{1 , 3} , … {t}_{1 , k} ] ;$$

$${t}_{2} = [ {t}_{2 , 1} , {t}_{2 , 2} , {t}_{2 , 3} , … {t}_{2 , k} ] ;$$

$$…$$

$${t}_{l} = [ {t}_{l , 1} , {t}_{l , 2} , {t}_{l , 3} , … {t}_{l , k} ] .$$

The last notation may be used to denote any chosen splitting into tuples by whatever method, and thus is more general.

Now consider a pair of functions, (f, g), which act on any tuple of length k, and are invertible (i.e. function g is the inverse of function f). Function f transforms any k-tuple t_{y} into some new k-tuple r_{z}, while function g transforms any such tuple r_{z} back into the original tuple t_{y}.

f(t_{y})→r_{z}=[r_{z,1},r_{z,2},r_{z,3}, . . . r_{z,k}];

g(r_{z})→t_{y}=[t_{y,1},t_{y,2},t_{y,3}, . . . t_{y,k}].

After applying the function f to the original ordered set of tuples, {t₁ . . . tₗ}, a new ordered set, {r₁ . . . rₗ}, is obtained as follows:

$${r}_{1} = [ {r}_{1 , 1} , {r}_{1 , 2} , {r}_{1 , 3} , … {r}_{1 , k} ] ;$$

$${r}_{2} = [ {r}_{2 , 1} , {r}_{2 , 2} , {r}_{2 , 3} , … {r}_{2 , k} ] ;$$

$$…$$

$${r}_{l} = [ {r}_{l , 1} , {r}_{l , 2} , {r}_{l , 3} , … {r}_{l , k} ] .$$

A set of k new data streams, {s₁, s₂, s₃, . . . sₖ}, can be created by selecting members of each stream from different tuples. As an example, one way to perform such an operation is as follows:

$${s}_{1} = [ {r}_{1 , 1} , {r}_{2 , 1} … {r}_{1 , 1} ] ;$$

$${s}_{2} = [ {r}_{1 , 2} , {r}_{2 , 2} , … {r}_{1 , 2} ] ;$$

$$…$$

$${s}_{k} = [ {r}_{1 , k} , {r}_{2 , k} , … {r}_{1 , k} ] .$$

The original stream S has now become a set of streams {s₁, s₂, s₃, . . . sₖ}. Depending on the chosen functions, (f, g), each of the individual streams sⱼ may be unintelligible. Therefore, the original stream of useful information S may not be read if one has obtained only one (or a few) of the k streams {s₁, s₂, s₃, . . . sₖ}. It is noted that various steps in the algorithm must be chosen to be invertible as follows:
(1) the method of splitting into k-tuples must be invertible so that the original stream S is reconstructed if one has the tuples {t₁ . . . tₗ};

(2) the function g must be the inverse of f; and

(3) the method of creating the new streams must be invertible so that given a set of streams {s₁, s₂, s₃, . . . sₖ}, one may always reconstruct the tuples . . . rd.

As a consequence, if one has obtained all the k streams {s₁, s₂, s₃, . . . sₖ}, then reversing the process above is simple.

As noted above, there are many possible choices of (f, g). However, not all choices are good ones for ensuring unintelligibility. As a trivial example of “bad” choices, consider the choice of the identity transformation f=I which takes each tuple into itself: f: t→t. While such a choice for function f is obviously invertible and well-defined, it also obviously a bad choice since the resulting streams {s₁, s₂, s₃, . . . sₖ} will each be quite intelligible individually.

It would be advantageous to devise a pair of functions (f, g) that meet the criteria defined above so that the stream S is difficult to reconstruct if any of the streams {s₁, s₂, s₃, . . . sₖ} is missing, but easy to reconstruct if {s₁, s₂, s₃, . . . sₖ} are available.

For example, consider the case where k=2, resulting in 2-tuples and two streams {s₁, s₂} being constructed. Further, each piece of data bₓ in the original stream S takes one of M values (e.g. if bₓ are ASCII bytes, then M is 256).

The function f may be defined by writing down an M×M matrix, where the rows and columns are numbered by the possible values 1 . . . M. Any 2-tuple [bᵢ, bⱼ] may then be identified with the bᵢ^{th} row and the bⱼ^{th} column of the matrix. To complete the definition of f, each cell in the M×M matrix is populated by some other 2-tuple. This population process must meet the following conditions:
(1) each possible 2-tuple must appear exactly once somewhere in the matrix; and
(2) the choice of the 2-tuple in each individual cell must be performed by a randomizing technique.

The first of these conditions ensures that f is invertible so that g exists and can also be constructed as an M×M matrix. Given some function R that generates random numbers between 1 and M², the second condition is fulfilled. An algorithm can be used to populate the matrix. Here are two examples of such algorithms; both examples assume there is a way to map a number in the range 1 . . . M² to a tuple.
(1) Run a loop that fills the matrix one tuple at a time, and ensure that each tuple is chosen exactly once by “rolling the dice” (running R) until a number is obtained that corresponds to a tuple that has not yet been chosen.
(2) Run a loop that fills the matrix one tuple at a time, and ensure that each tuple is chosen exactly once by calculating the modulus of R with the number of tuples that have not yet been chosen and using that to find a tuple.

This technique is now easily generalized to apply for k-tuples, where k is any desired integer. The matrix is taken to be k-dimensional, and the random function R must be chosen to provide random or pseudo-random numbers between 1 and M^{k}. Note that the technique for constructing f is actually general. A k-dimensional matrix is actually a completely general way to describe an invertible function f that operates on the space of k-tuples. Furthermore, a truly random R may produce any ordering of values in the matrix. Therefore, any other technique for constructing f is actually a sub-technique or equivalent of this technique.

An additional aspect, which further develops the previous embodiment of the present invention, applies the stream-distribution algorithm to the case of a distributed resource. Consider the original stream of data S which has been transformed into the unintelligible ordered set of streams {s₁, s₂, s₃, . . . sₖ}. Let the streams be stored in a distributed resource which allows data storage. The distributed resource is designed to allow storage, usually offering an API for this purpose.

Suppose for concreteness that the stream S has some unique name K, which is used as its identifier, and that each of the streams {s₁, s₂, s₃, . . . sₖ} is saved and may be found within the distributed resource by means of a key, creating an ordered set of keys {K₁, K₂, K₃, . . . Kₖ}.

The streams {s₁, s₂, s₃, . . . sₖ} are saved in the distributed storage resource in such a way that the resource does not contain any intelligible reference or cross-reference, so there is no way to know that these streams “belong to each other.” In other words, the values of the keys have no discernible relationship with each other nor with K, and no other “metadata” is saved that may offer a hint of such a relationship.

The relationship is, of course, necessary for retrieving {s₁, s₂, s₃, . . . sₖ} and reconstructing the original stream S. The information regarding the relationship between these streams may be saved, for example, as follows:
(1) in a separate, appropriately-secure place;
(2) encoded through one-way encryption in the keys {K₁, K₂, K₃, . . . Kₖ} or metadata such that:
   a. only an authorized agent knowing: the relationships, the unique name K, the details of function f, and the one-way encoding of the keys can create the correct values of key {K₁, K₂, K₃, . . . Kₖ} and retrieve {s₁, s₂, s₃, . . . sₖ}; and
   b. because of the one-way character of the encoding, the unique name K and the relationships cannot be inferred from the values of {K₁, K₂, K₃, . . . Kₖ} or the metadata; or
(3) encoded through symmetric encryption of the keys {K₁, K₂, K₃, . . . Kₖ} or metadata.

The consequences of the combination of these techniques, as embodied in the present invention, in the context of a distributed storage resource creates a very new situation. By the very nature of distributed resources, there are often no guarantees on the physical location of any stream saved in the resource. Suppose a malicious attacker gains access to the physical storage of the distributed resource. Such a resource, by its nature, stores many streams of data from many subscribers.
The streams {s₁, s₂, s₃, . . . sₖ} are typically a very small portion of the data saved in the distributed storage resource.
Each of the streams {s₁, s₂, s₃, . . . sₖ} is generally saved at a specific physical location within the distributed resource.
Each of the streams {s₁, s₂, s₃, . . . sₖ} is saved without reference or cross-reference to the other streams.
Each of the streams is individually unintelligible.

As a consequence, the malicious attacker (having stolen the physical storage media of the distributed resource) still faces great difficulty in reconstructing the original stream S. So, the distributed and shared nature of the resource, which is usually viewed as compromising security, has in this case enhanced the security. Thus, the distributed nature of the resource has been exploited to enhance security or safety.

As mentioned above, encryption may be used as one of the “rich security measures” for proxy implementations as well as other deployment solutions (e.g. drivers). In addition, cryptography can be used to further enhance the previously-described embodiments. Encryption may be used to secure the communications between the user and the deployment mechanism (e.g. proxy, driver, or plug-in), as well as the communication between the deployment mechanism and the distributed resource (e.g. by using SSL or SSH protocols). The original stream S may be encrypted before apply the algorithm detailed above. Each of the individual streams {s₁, s₂, s₃, . . . sₖ} may be encrypted before being stored. Digital-signature techniques may be used to ensure the integrity of S or any of the streams {s₁, s₂, s₃, . . . sₖ}.

All of these techniques, separately or in combination, make it even harder to reconstruct the original stream S without authorized access to the appropriate cryptographic keys and the unique name K. In particular, combinations of these techniques (as embodied in the present invention) make it so hard for unauthorized individuals to reconstruct S that even staff of the resource provider (should they become malicious) would find great difficulty in compromising the security of a message containing S.

Note that each of the “secrets” necessary for reconstructing S may be in places unavailable to the staff of the resource provider or to the automated mechanisms of the resource provider. The name K may be known only to the user or to an authorized agent who is unrelated to the resource provider. The cryptographic keys are also known only to the user or to an authorized agent who is unrelated to the resource provider. This enables a trusted environment to be created, even in a situation where there is imperfect trust in the resource provider or their staff.

It is noted, on the other hand, that if malicious attackers did somehow obtain the unique name K and some of the cryptographic keys (e.g. those that encrypt S in point 2 above), the attackers still have to contend with the other techniques introduced in the embodiments (e.g. the one-way encryption of keys and the distribution into unintelligible physically-unrelated streams {s₁, s₂, s₃, . . . sₖ}). Therefore, the approach provides multiple “layers of defense in depth” that strengthen and harden each other.

While the general case of k-tuples has been treated above, note that the case with k=1 is also covered. Cryptographic techniques provide encryption “at rest and in transit” for the single stream S. In the cases k>1, encryption is provided at rest and in transit for each of the streams S and {s₁, s₂, s₃, . . . sₖ}.

As a further enhancement of the resource interface proxy, embodiments of the present invention utilize several techniques that protect against several types of loss of service. When information is passed to (or from) a distributed resource, and a resource interface proxy is in use as described above, the proxy has an opportunity to create several copies of the data. The advantage of such copies is that any failure of one distributed-resource provider is overcome by turning to one of the other providers to retrieve the necessary data.

Since the resource interface proxy is able to communicate with more than one distributed resource, the proxy may enhance the safety of the data by making copies to several such distributed resources. There are different possible strategies for performing such distributed copying such as:
(1) Primary/secondary strategy: one resource is considered the primary resource, and implementation is optimized so that communication and response from the primary resource are fastest;
   a. other resources are considered secondary or back-up resources; communication with the secondary resources is done during “idle time” or other times when the proxy has capacity that is not used in immediate communication with the user or the primary resource;
   b. a technique for queuing information into the proxy, and saving the information into secondary resources when the proxy has capacity to do so, is used; or
(2) Symmetric strategy: all resources able to provide a desired service (such as storage) are considered equal; the proxy tries to perform a user request by communicating with all of the resources, or selecting some of the resources by some appropriate technique such as balancing load between the different available resources.

This approach is further enhanced by including algorithms and logic that ensure high availability of data. When one resource is down (even if it is a primary resource), the resource interface proxy detects the issue using appropriate algorithms, and turns to another resource to fulfill a request. Optionally, the proxy can also change the status of a resource from secondary to primary in order to fulfill a request when a primary resource is down.

There are situations in which the distributed resource is providing a service (e.g. computing capacity or application services). Such services do not necessarily deal with storing data. Still, a user may desire to have high availability in such services. Since the resource interface proxy is able to communicate with more than one distributed resource, the proxy may enhance the high availability of the desired service by using more than one provider to provide the service. The proxy may use appropriate techniques to identify the loss of service from one provider, and pass user requests to other providers. Again, there are different possible strategies for performing such distributed service availability such as the primary/secondary and symmetric strategies described above.

A further point is that the resource interface proxy itself is (of course) using services (e.g. computing capacity), and is itself an application offering a service (i.e. the proxy service). The approaches described above can therefore be applied to the resource interface proxy itself, which may be implemented in a distributed manner using resources from several providers.

In such an approach, instances of the resource interface proxy exist in a distributed fashion among several providers. Access to the proxy involves selection of one of the possible proxies in this distributed scenario. Such selection is achieved by load-balancing techniques.

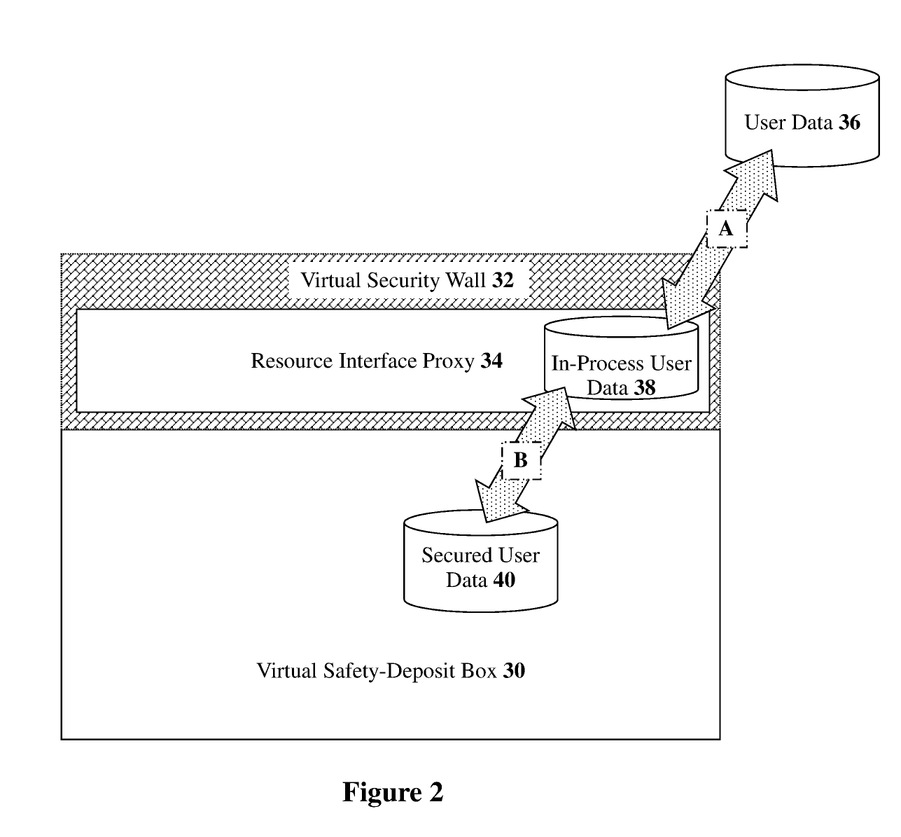

FIG. 2 is a simplified schematic block diagram of a virtual safety-deposit box implemented using a resource interface proxy, according to preferred embodiments of the present invention. A virtual safety-deposit box 30, built using regular distributed storage resources that are available to the user, is shown in FIG. 1. Virtual safety-deposit box 30 uses non-secured resources to implement a secure solution in such embodiments. A virtual security wall 32 includes a resource interface proxy 34 as well as accepted firewall technologies to enhance security.

Virtual safety-deposit box 30 is itself a distributed resource, using existing distributed resources to provide a new secured distributed resource. Data in virtual safety-deposit box 30 is treated similarly to money in a bank, meaning a user:
Deposits user data 36 at will: communicating user data 36 over a network to virtual safety-deposit box 30 in which virtual security wall 32 checks user data 36 while the data is being processed by resource interface proxy 34 as in-process user data 38 (Transfer Process A) for purposes of securely storing user data 36 as secured user data 40 in virtual safety-deposit box 30 (Transfer Process B); and
Withdraws user data 36 at will: communicating with virtual safety-deposit box 30 over a network via Transfer Processes A and B for purposes of obtaining previously-stored user data 36.

Once user data 36 has been deposited in virtual safety-deposit box 30, user data 36 is safely secured as secured user data 40. Resource interface proxy 34 is implemented to apply rich security measures whenever user data 36 is “deposited” into virtual safety-deposit box 30. In implementations, Transfer Processes A and B are performed as follows:
(1) user desires to securely store user data 36 in virtual safety-deposit box 30;
(2) at virtual security wall 32, firewall techniques are applied to protect virtual safety-deposit box 30 against attacks, and resource interface proxy 34 (which is distributed) applies rich security measures to in-process user data 38 (Transfer Processes A);
(3) in-process user data 38 is stored within virtual safety-deposit box 30 as secured user data 40 (Transfer Processes B) (i.e. user data 36 is stored in a distributed storage resource, meaning that a non-secured distributed storage resource is used in a secure manner); and
(4) when the user makes a “withdrawal” request for user data 36, secured user data 40 first travels to virtual security wall 32 (Transfer Processes B) in which:
   a. firewall (as well as authentication/authorization) techniques ensure that no unauthorized request is provided user data 36; and
   b. resource interface proxy 34 applies rich security measures, and performs any necessary decryption or decoding on in-process user data 38 so the user may obtain user data 36 (Transfer Processes A).

It is noted that the rich security measures mentioned above also include secured communication, meaning Transfer Processes A and B are secure communications (when configured). As a result of such an implementation, the user may make use of available non-secured distributed resources with all the economic, operational, and technical benefits of such resources. Yet, at the same time, the user may enjoy a fully-secured environment knowing that user data 36 is safe while residing in virtual safety-deposit box 30. Safety, in the context of the embodiments described above, implies both safety from security breaches and safety from data loss or corruption.

Embodiments of the present invention mentioned may be further enhanced. Examples of such enhancements include:
Deployment Options: deployment within clouds, customer private networks, or hybrid combinations of these.
Virtual Private Networks (VPNs): deployment within the perimeters of VPNs to provide further security features.
Authentication, Identification, and Authorization: enhancements providing techniques for authentication, authorization of users, and managing identities.
Key Management: enhancements providing management and ownership of security keys and encryption keys.
Logging: enhancements providing logging of events and messages.
Analysis: enhancements providing log analysis, including event, message, and system logs for security and safety (e.g. forensic analysis).
Scanning: enhancements providing system scans to discover security or safety issues.
Modular Implementation: enhancements providing either complete security solutions or specific components that meet customer needs.

While the present invention has been described with respect to a limited number of embodiments, it will be appreciated that many variations, modifications, and other applications of the invention may be made.

What is claimed is:

1. A method for securing information by transforming the information into individually-unintelligible parts, the method comprising the steps of:
(a) dividing an original data stream into a set of split data streams;
(b) applying a first invertible transformation function to said split data streams, said step of applying producing an intermediate set of data streams; and
(c) extracting a final set of data streams from said intermediate set by applying a selection rule which produces said final set, thereby transforming said original data stream into individually-unintelligible parts in said final set.

2. The method of claim 1, wherein said first invertible transformation function requires all elements of said final set to be available in order to reconstruct said original data stream.

3. The method of claim 1, the method further comprising the steps of:
(d) applying a second invertible transformation function to said final set to produce said intermediate set, wherein said second invertible transformation is an inverse function of said first invertible transformation;
(e) extracting said split streams from said intermediate set by applying a selection rule which produces said split data streams; and
(f) reconstructing said original data stream from said split data streams.

4. The method of claim 1, the method further comprising the steps of:
(d) associating a key set with said final set such that every element of said final set has an associated key;
(e) storing said final set on a computing-service resource, wherein said key set specifies locations of said elements in said computing-service resource; and
(f) ensuring that no intelligible reference regarding a key relationship between said key set and said final set is present on said computing-service resource, thereby preventing detection of said elements by masking an element relationship among said elements.

5. A non-transitory computer-readable storage medium having computer-readable code embodied on the non-transitory computer-readable storage medium, the computer-readable code comprising:
(a) program code for dividing an original data stream into a set of split data streams;
(b) program code for applying a first invertible transformation function to said split data streams, said applying producing an intermediate set of data streams; and
(c) program code for extracting a final set of data streams from said intermediate set by applying a selection rule which produces said final set, thereby transforming said original data stream into individually-unintelligible parts in said final set.

6. The non-transitory computer-readable storage medium of claim 5, wherein said first invertible transformation function requires all elements of said final set to be available in order to reconstruct said original data stream.

7. The non-transitory computer-readable storage medium of claim 5, the computer-readable code further comprising:
(d) program code for applying a second invertible transformation function to said final set to produce said intermediate set, wherein said second invertible transformation is an inverse function of said first invertible transformation;
(e) program code for extracting said split streams from said intermediate set by applying a selection rule which produces said split data streams; and
(f) program code for reconstructing said original data stream from said split data streams.

8. The non-transitory computer-readable storage medium of claim 5, the computer-readable code further comprising:
(d) program code for associating a key set with said final set such that every element of said final set has an associated key;
(e) program code for storing said final set on a computing-service resource, wherein said key set specifies locations of said elements in said computing-service resource; and
(f) program code for ensuring that no intelligible reference regarding a key relationship between said key set and said final set is present on said computing-service resource, thereby preventing detection of said elements by masking an element relationship among said elements.

9. A device for securing information by transforming the information into individually-unintelligible parts, the device comprising:
(a) a data-processing unit including:
(i) a CPU for performing computational operations; and
(ii) a memory module for storing data; and
(b) a deployed security mechanism, residing on said data-processing unit, configured for:
(i) dividing an original data stream into a set of split data streams;
(ii) applying a first invertible transformation function to said split data streams, said step of applying producing an intermediate set of data streams; and
(iii) extracting a final set of data streams from said intermediate set by applying a selection rule which produces said final set, thereby transforming said original data stream into individually-unintelligible parts in said final set.

10. The device of claim 9, wherein said first invertible transformation function requires all elements of said final set to be available in order to reconstruct said original data stream.

11. The device of claim 9, wherein said deployed security mechanism is further configured for:
(iv) applying a second invertible transformation function to said final set to produce said intermediate set, wherein said second invertible transformation is an inverse function of said first invertible transformation;
(v) extracting said split streams from said intermediate set by applying a selection rule which produces said split data streams; and
(vi) reconstructing said original data stream from said split data streams.

12. The device of claim 9, wherein said deployed security mechanism is further configured for:
(iv) associating a key set with said final set such that every element of said final set has an associated key;
(v) storing said final set on a computing-service resource, wherein said key set specifies locations of said elements in said computing-service resource; and
(vi) ensuring that no intelligible reference regarding a key relationship between said key set and said final set is present on said computing-service resource, thereby preventing detection of said elements by masking an element relationship among said elements.
